(19) United States
(12) Patent Application Publication
(10) Pub. No.: US 2005/0078661 A1
(43) Pub. Date: Apr. 14, 2005

(54) Exchange for making communication among digital devices and analog devices

(76) Inventors: Jung-Jen Weng, Kaohsiung (TW); Rong-Tarng Yu, Kaohsiung (TW); Yuan-Shiang Chang, Taipei (TW); Ju-Hang Kuo, Taipei (TW)

Correspondence Address: BIRCH STEWART KOLASCH & BIRCH, PO BOX 747, FALLS CHURCH, VA, 22040-0747, US

(21) Appl. No.: 10/960,971

(22) Filed: Oct. 12, 2004

(30) Foreign Application Priority Data
Oct. 14, 2003 (TW) 92128400

(51) Int. Cl. H04L 12/66

(52) U.S. Cl. 370/352; 370/401

(57) ABSTRACT

A communication exchange including a digital route module, an analog route module and a call manager is presented. The digital route module transmits a call signal of a call as the call signal is a digital signal. The analog route module transmits the call signal as the call signal is an analog signal. The call manager has a processor for identifying the call alternatively occurring in the digital route module or the analog route module. The call manager also selects alternatively the digital route module and the analog route module to send the call signal to a destination of the call. Wherein the digital route module together with the call manager are used for signals transmission among the plurality of digital devices, and the analog route module together with the call manager are used for signals transmission among the plurality of analog devices.

### CROSS REFERENCE TO RELATED APPLICATIONS

This application claims priority of Taiwan Patent Application Serial No. 092128400 filed on Oct. 14, 2003.

### FIELD OF INVENTION

The present invention relates to a communication exchange for exchanging and delivering digital signals and analog signals among a plurality of devices.

### BACKGROUND OF THE INVENTION

Conventional telecommunication systems typically provide telephony and fax services. As appreciated by one of ordinary skill in the art, communication exchanges are core components in a telephony system to connect subscribers through private telephony networks and/or public telephony networks. However, information technologies are well developed nowadays so that networks for data communication are necessary to provide efficient information services including e-mail, instant-messaging, etc.

The Internet Protocol (IP) was created in the 1970s to support early computer networking with the Unix operating system. Today, IP has become a standard for all modern network operating systems (NOS) to communicate with each other. Many popular higher-level protocols such as. HTTP and TCP rely on IP. In addition, other applications using IP are mushrooming. One of them is to transmit digitized voice data via the Internet. Even with the poor voice quality at the beginning, the available increasing bandwidth and the improved data compression technology cause Voice over IP (VoIP) become another important service on the Internet. Thus solutions to integrate the conventional telephony network and VoIP are desirable in these years.

For example, Cisco Systems brings up its IP Phone 7900 Series, which is configured in a data network, such as Ethernet, to provide telephony service. Moreover, with the wireless capability of IEEE 802.11b protocol, IP Phone 7920 of Cisco becomes a phone for wireless local area network. In Cisco's solution, IP PBX is the core component to exchange voice signals between conventional phones and IP phones. However, it doesn't provide data exchange for as applications of WWW, FTP, file sharing, etc., which are performed by network components such as hubs, switches, and routers.

Therefore, it is desirable to integrate IP PBX described above and hubs, switches, or routers to meet the needs of the SOHO users and small enterprises. And it will be more advantageous if the wireless communication capabilities can be integrated.

### SUMMARY OF THE INVENTION

The main aspect of the present invention is to provide a communication exchange. The communication exchange includes a processor for executing a program to exchange and deliver digital signals and analog signals among a plurality of devices.

Another aspect of the present invention is to integrate PSTN, Internet, LAN, WLAN, and VoWLAN. The communication exchange of the present invention is adapted to be the gateway in these existing communication networks. Moreover, the communication exchange of the present invention integrates communication capabilities of prior arts for respective communication networks (e.g., PBX for PSTN, hub for LAN) to exchange and deliver signals over different networks.

In a first embodiment, a communication exchange provides communication among a plurality of digital devices and a plurality of analog devices. The communication exchange includes a digital route module, an analog route module, and a call manager. The digital route module transmits a call signal of a call as the call signal is a digital signal. The analog route module transmits the call signal as the call signal is an analog signal. The call manager has a processor for identifying the call occurring either in the digital route module or the analog route module. The call manager selects the digital route module or the analog route module to send the call signal to a destination of the call. The call manager further identifies a completion of the call. The digital route module together with the call manager are used for signals transmission among the plurality of digital devices, and the analog route module together with the call manager are used for signals transmission among the plurality of analog devices.

In another embodiment, the communication exchange further includes a signal converter for transforming the call signal between digital and analog signals. The signal converter, the digital route module, the analog module, and the call manager cooperate to provide signals transmission among the plurality of digital devices and the plurality of analog devices.

The present invention also provides a computer readable medium having a code segment executable by the communication exchange of the first embodiment for executing: (a) identifying the call occurring in the digital route module or the analog route module; (b) selecting the digital route module or the analog route module to send the call signal to the destination of the call; and (c) identifying the completion of the call.

### BRIEF DESCRIPTION OF THE DRAWINGS

FIG. 1 is a diagram of a communication exchange according to an embodiment of the present invention;

FIG. 2 is a diagram of an application of a communication exchange according to another embodiment of the present invention, and

FIG. 3 is a flowchart according to an embodiment of the present invention.

### DETAILED DESCRIPTION

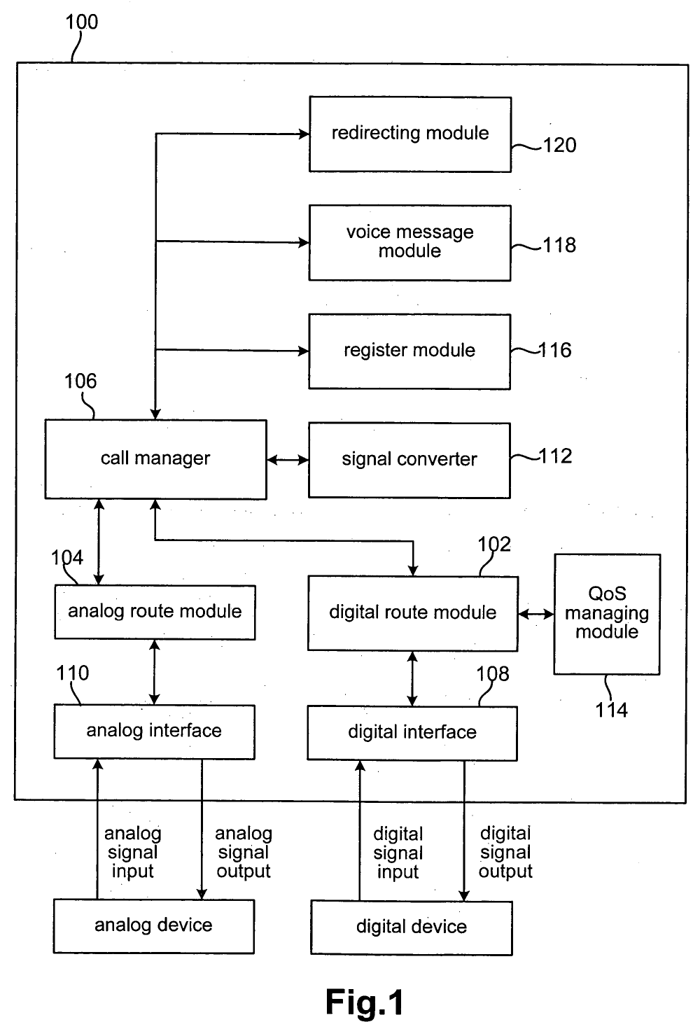

As shown in FIG. 1, a communication exchange 100 provides communication among a plurality of digital devices and a plurality of analog devices. The communication exchange 100 includes a digital route module 102, an analog route module 104, and a call manager 106. The digital route module 102 has a digital interface 108, and the analog route module 104 has an analog interface 110. The communication exchange 100 receives and sends signal via the digital interface 108 or the analog interface 110. The digital route module 102 and/or the analog route module 104 deliver a call signal of a call inside the communication exchange 100. It should be noted that “call” described hereinafter refers to a request to transmit and receive a signal. For example, a voice call requests to transmit and receive a voice signal, and a data call requests to transmit and receive a data signal. The digital route module 102 transmits the call signal as the call signal is a digital signal, and the analog route module 104 transmits the call signal as the call signal is an analog signal. The call manager 106 has a processor (not shown) for executing a program to identify the call occurring in the digital route module 102 or the analog route module 104. The call manager 106 selects the digital route module 102 and the analog route module 104 to send the call signal to a destination of the call. The call manager 106 further identifies a completion of the call. The digital route module 102 together with the call manager 106 are used for signals transmission among the plurality of digital devices, and the analog route module 104 together with the call manager 106 are used for signals transmission among the plurality of analog devices.

The communication exchange 100 further includes a signal converter 112 for transforming the call signal between digital and analog signals. The signal converter 112, the digital route module 102, the analog module 104, and the call manager 106 cooperate to provide signals transmission among the plurality of digital devices and the plurality of analog devices. It should be noted that the call manager 106 may, but be not limited to, be implemented as a processor of a personal computer to execute a program, which is downloaded or updated via the Internet. The call manager 106 is not limited to costly workstations and complicated operating systems.

Besides, the analog route module 104 together with the call manager 106 performs signals exchange in a public switched telephone network (PSTN). In this embodiment, the communication exchange 100 serves ass a private branch exchange (PBX) connecting the PSTN and private lines. Furthermore, as the analog interface 104 includes a wireless linking module, the communication exchange 100 becomes a wireless PBX or a base unit wirelessly connecting the cordless handsets to the PSTN.

With respect to digital signals, the digital route module 102 and the call manager 106 make the communication exchange 100 become an apparatus of Digital Enhanced Cordless Telecommunications (DECT) for exchanging digitized voice signal among a plurality of handsets. The communication exchange 100 transforms the call signal from the digital signal received from the handsets of DECT to the analog signal sent to the PSTN. In still another embodiment, the communication exchange 100 is further connected to the Internet via a network connection port and other network components. The digital route module 102 and the call manager 106 make the communication exchange 100 become a network router, a network switch, or a network hub, to exchange and deliver signals through a local area network (LAN). The details about the DECT, the network router, the network switch, and a network hub are known to those skilled in the art and thus are omitted herein.

The call manager 106 may, but be not limited to, use well known Session Initiation Protocol (SIP) to identify the call occurring in the digital route module 102 or the analog route module 104, then select the digital route module 102 or the analog route module 104 to send the call signal to a destination of the call, and identify the completion of the call. SIP enhances the efficiency while transmitting voice, image, and other data through the Internet. The digital route module 102 together with the call manager 106 further performs signals exchange for a voice over IP (VoIP) application in a local area network (LAN). It is noted that the local area network can be connected to the Internet or the PSTN.

To provide the VoIP application, the communication exchange 100 further includes a quality of service (QoS) managing module 114 for maintaining voice quality of the VoIP application. The QoS managing module 114 provides functions such as “call admission control”, “traffic control”, “bandwidth management”, “packet scheduling”, “buffer management”, and “packet classification”.

The communication exchange 100 includes a register module 116 for registering a client of the VoIP application and authenticating the client as the client requests the VoIP application, such as the requests to receive or send a signal. The communication exchange 100 also includes a voice message module 118 for users of the plurality of digital devices and the plurality of analog devices to leave and/or retrieve voice messages via the VoIP network or the PSTN. The communication exchange 100 further includes a redirecting module 120 for redirecting the call based on preferences of users. In one embodiment, the redirecting module 120 provides the redirecting function only in the domain supported by the communication exchange 100, e.g. a LAN, where clients are connected directly to the communication exchange 100. In another embodiment, the redirecting module 120 provides the redirecting function across a number of domains supported respectively by multiple communication exchanges 100 connected to each other.

In an embodiment, the digital interface 108 includes a wireless access point, whereby the digital route module 102 together with the call manager 106 performs signals exchange in a wireless local area network (WLAN). In another embodiment, the digital route module 102 together with the call manager 106 performs signals exchange for a voice over wireless LAN (VoWLAN) application in a WLAN.

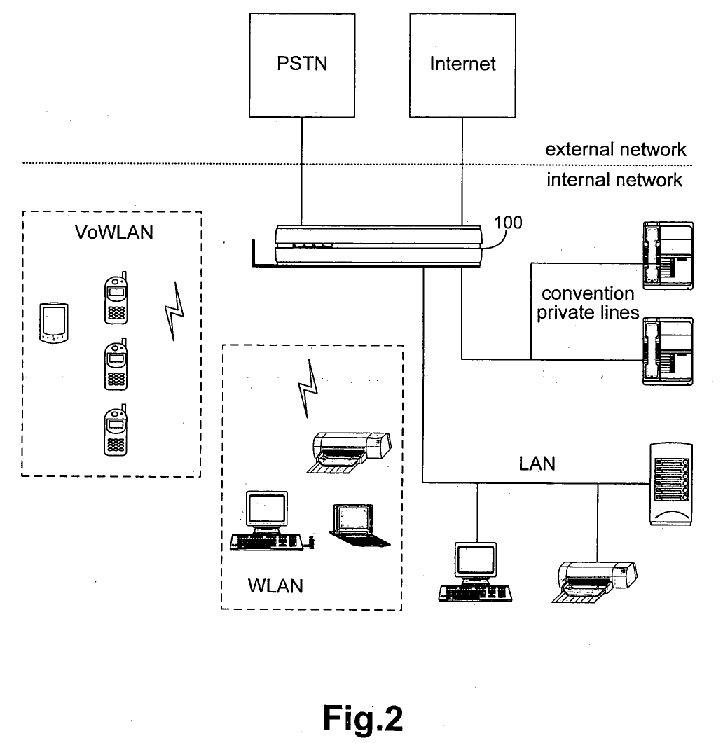

In FIG. 2, the communication exchange 100 not only externally connects to the PSTN and the Internet, but also serves as a PBX to internally support the private phone lines. When placed in a LAN or a WLAN, the communication exchange 100 is provided as a network hub, a network switch, or a network router to connect the Internet, LAN, and WLAN. As for the VoWLAN application, the communication exchange 100 provides three functions: (1). connecting the VoWLAN application to the PSTN; (2). connecting the VoWLAN application to the Internet; and (3). connecting the VoWLAN to the LAN, the WLAN, or the conventional private phone lines. The communication exchange 100 also transforms the call signal between digital and analog signals when transformation is necessary for these three functions.

The communication exchange 100 includes a register module 116 for registering a client of the VoWLAN application and authenticating the client as the client requests the VoWLAN application, such as the requests to receive or send a signal. The communication exchange 100 also includes a voice message module 118 for users of the plurality of digital devices and the plurality of analog devices to leave and/or retrieve voice messages via the VoWLAN network, VoIP network, or the PSTN. The communication exchange 100 further includes a redirecting module 120 for redirecting the call based on preferences of users of the plurality of digital devices and the plurality of analog devices.

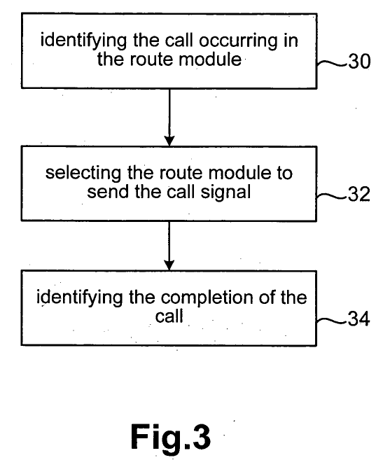

A computer readable medium is provided for having a code segment executable by the communication exchange 100 disclosed in FIG. 3. In the step 30, the method is to identify the call occurring in the digital route module or the analog route module. In one embodiment, in the step 30, the call manager 106 uses the SIP to identify the source and the destination of the call and the format of the call signal. For example, the call manager 106 identifies the call signal as a digital signal or a digitized voice signal for VoIP. Furthermore, in the step 30, the call manager identifies whether the call signal needs to be transformed. Next, the step 32 is to select the digital route module or the analog route module to send the call signal to the destination of the call based on the destination and the format of the call signal. And the step 34 is to identify the completion of the call.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A communication exchange for providing communication among a plurality of digital devices and a plurality of analog devices, said communication exchange comprising:
a plurality of route modules for transmitting a call signal of a call, said plurality of route modules comprising:
a digital route module for transmitting said call signal as said call signal is a digital signal; and
an analog route module for transmitting said call signal as said call signal is an analog signal; and
a call manager having a processor for identifying said call occurring in any one of said plurality of route modules, selecting a route module from said plurality of route modules to send said call signal to a destination of said call, and identifying a completion of said call;
wherein, said digital route module together with said call manager are used for signals transmission among said plurality of digital devices, and said analog route module together with said call manager are used for signals transmission among said plurality of analog devices.

2. The communication exchange of claim 1, comprising:
a signal converter for transforming said call signal between digital and analog signals;
wherein said signal converter, said digital route module, said analog module, and said call manager cooperate to provide signals transmission among said plurality of digital devices and said plurality of analog devices.

3. The communication exchange of claim 1 wherein said analog route module together with said call manager performs signals exchange in a public switched telephone network (PSTN).

4. The communication exchange of claim 2, wherein said communication exchange includes a private branch exchange (PBX).

5. The communication exchange of claim 2, wherein said communication exchange includes a wireless private branch exchange.

6. The communication exchange of claim 5, wherein said communication exchange includes an exchange for Digital Enhanced Cordless Telecommunications (DECT).

7. The communication exchange of claim 2, wherein said communication exchange includes a network router.

8. The communication exchange of claim 2, wherein said digital route module together with said call manager performs signals exchange in a local area network (LAN).

9. The communication exchange of claim 8, wherein said digital route module together with said call manager further performs signals exchange for a voice over IP (VoIP) application in said local area network (LAN).

10. The communication exchange of claim 9, further comprising a quality of service (QoS) managing module for maintaining voice quality of said voice over IP (VoIP) application.

11. The communication exchange of claim 9, further comprising a register module for registering a client of said voice over IP (VoIP) application and authenticating said client as said client requests said voice over IP (VoIP) application.

12. The communication exchange of claim 9, further comprising a voice message module for users of said plurality of digital devices and said plurality of analog devices to leave and/or retrieve voice messages.

13. The communication exchange of claim 9, further comprising a redirecting module for redirecting said call based on preferences of users of said plurality of digital devices and said plurality of analog devices.

14. The communication exchange of claim 2, wherein said digital route module together with said call manager performs signals exchange in a wireless local area network (WLAN).

15. The communication exchange of claim 14, wherein said digital route module together with said call manager further performs signals exchange for a voice over wireless LAN (VoWLAN) application in said wireless local area network (LAN).

16. The communication exchange of claim 2, wherein said call manager executes a program to identify said call occurring in any one of said plurality of route modules, select said route module from said plurality of route modules to send said call signal to said destination of said call, and identify said completion of said call, said program is downloaded or updated via Internet.

17. A computer readable medium, having a code segment executable by the communication exchange of claim 1, for executing a method, said method comprising:
(a) identifying said call occurring in any one of said plurality of route modules;
(b) selecting said route module from said plurality of route modules to send said call signal to a destination of said call; and
(c) identifying a completion of said call.

18. The computer readable medium of claim 17, wherein step (a) further comprises:
identifying whether said call includes a digital voice signal as said call occurs in said digital route module.

19. The computer readable medium of claim 17, wherein said method further comprises:
transforming said call signal into a digital signal as said call occurs in said analog route module.

20. The computer readable medium of claim 17, wherein said method further comprises:
transforming said call signal into an analog signal as said call occurs is that digital route module.
